(19) United States
(12) Patent Application Publication
(10) Pub. No.: US 2009/0271646 A1
(43) Pub. Date: Oct. 29, 2009

(54) Power Management Using Clustering In A Multicore System

(76) Inventors: Vanish Talwar, Palo Alto, CA (US); Partha Ranganathan, Fremont, CA (US); Sanjay Kumar, Atlanta, GA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/263,411

(22) Filed: Oct. 31, 2008

Related U.S. Application Data
(60) Provisional application No. 61/047,552, filed on Apr. 24, 2008.

(51) Int. Cl. G06F 1/26; G06F 1/32

(52) U.S. Cl. 713/322; 713/300

(57) ABSTRACT

A multi-core system including cores and voltage sources supplying power to the cores. The cores are divided into clusters based on the particular voltage source supplying power to each core. Power management is performed in the multi-core system based on one or more of core utilization and a management policy.

### CROSS-REFERENCE TO RELATED APPLICATION

The present application claims priority from provisional application Ser. No. 61/047,552, filed Apr. 24, 2008, the contents of which are incorporated herein by reference in their entirety.

### BACKGROUND

One important aspect of power management for computer systems pertains to minimizing the power consumption of such systems while keeping the performance degradation as small as possible. The central processing unit (CPU) is generally the biggest power consumer in modern computer systems. The most popular technique used for CPU power management is dynamic voltage frequency scaling (DVFS). Modern CPUs have the capability of running at multiple frequencies which is exploited by this technique. The relation between the frequency (F), voltage (V) and power (P) of a CPU is approximately given by the following Equation 1: PαFV². Also the frequency of the CPU is roughly linear in voltage. Hence, if the CPU frequency is reduced, the required voltage is reduced, and both collectively reduce the power consumption of the CPU.

DVFS exploits the property expressed in Equation 1 by dynamically reducing the CPU frequency to save power. However, reducing the frequency of a CPU causes the performance of applications running on the CPU to be adversely affected. To minimize degradation of application performance, DVFS reduces the frequency when the CPU utilization is below a certain threshold and increases the frequency when the CPU utilization goes above a certain threshold. For example, if the CPU utilization goes below 50%, the CPU frequency may be reduced, and if the CPU utilization goes above 80%, the CPU frequency may be increased.

While this approach works for systems with one processor per chip, it is not as efficient in multi-core systems (multiple processors on the same chip), also known as chip multiprocessors (CMP). Although these systems have multiple processors on the same chip, they don't have the same number of individual voltage sources for these processors. Consequently, in current multi-core systems, all the processors use a single voltage source which renders frequency scaling technique often inefficient. For example, if there are two processors on the same chip using a single voltage source and one processor's frequency is scaled down, the voltage to the processor doesn't change because the other processor is still running at a higher frequency and needs the higher voltage. Hence according to Equation 1, the power savings for the scaled down CPU is much less compared to the situation with reduced voltage.

### BRIEF DESCRIPTION OF DRAWINGS

The embodiments of the invention will be described in detail in the following description with reference to the following figures.

FIG. 1 illustrates a system, according to an embodiment;

FIG. 2 illustrates an example of power management in a multi-core system, according to an embodiment;

FIG. 3 illustrates a flow chart of a method for power management, according to an embodiments; and

FIG. 4 illustrates a flow chart of a method for power management, according to an embodiments.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

According to an embodiment, power management is performed in a multi-core system. The multi-core system may include a multi-core chip with cores and voltage sources, and there are more cores than voltage sources. The cores and voltage sources are divided into clusters, whereby multiple cores in a cluster receive power from a single voltage source. In other words, one voltage source provides current to a set of cores, and the set contains more than one core. Each set is referred to as a volt-cpu-set or a cluster. Power management is performed in the system based on the clustering and CPU utilization of the cores.

According to an embodiment, all the cores in a cluster are maintained at a single frequency. During power management, the frequency of all cores in a cluster is reduced, because reducing the frequency of one core in a cluster provides insignificant power savings unless all the cores in the cluster have their frequency reduced. Note that currently, the voltage sources for cores in a conventional multi-core chip are at the motherboard socket granularity, i.e., there is only one voltage source for all the cores of a chip plugged into a motherboard socket. Thus, the mult-core chip with multiple clusters and the clustering for performing power management described in the embodiments is a stark contrast to conventional multi-core chips and conventional DVFS.

The system may include a virtualized environment with virtual machines (VMs) hosted by cores in different clusters. VMs may be migrated between clusters to efficiently manage power consumption and minimize performance degradation of applications hosted by the VMs. For example, different clusters run at different frequencies. When an application needs a higher CPU frequency (because of higher CPU utilization), instead of incrementing the core's frequency to next higher value, the application is migrated to a cluster which is running at a higher frequency.

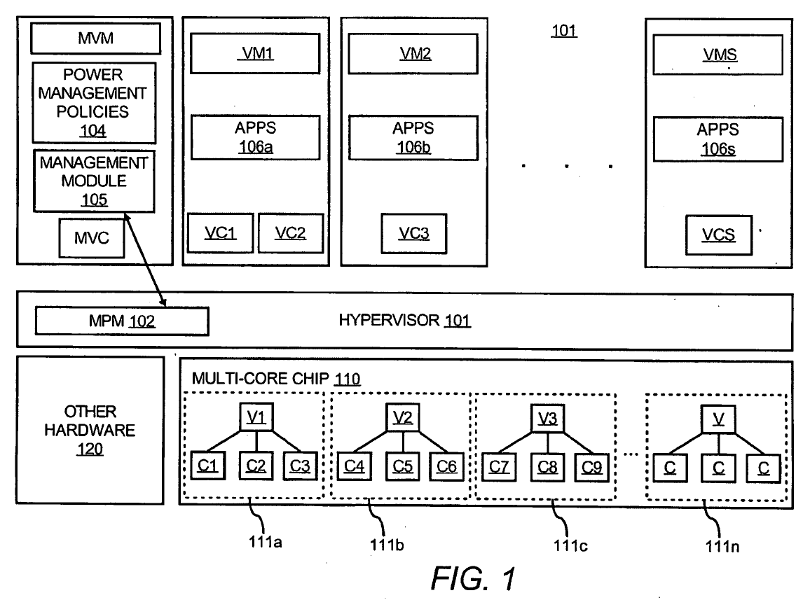

FIG. 1 illustrates a multi-core computer system 100, according to an embodiment. The system 100 includes a multi-core chip 110. The multi-core chip 110 includes clusters (i.e., volt-cpu-sets) 111a-n. Each cluster, in this example, includes one voltage source V supplying power to three cores C. For example, cluster 111a includes voltage source V1 and cores C1-C3, cluster 111b includes voltage source V2 and cores C4-C6, etc. FIG. 1 shows one embodiment having chip with a particular number of voltage sources and cores, wherein each cluster includes a single voltage and multiple cores. It will be apparent to one of ordinary skill in the art that the chip 110 may include any number of voltage sources and cores, however, there may be less voltage sources than cores on the chip. Also, each cluster may include more or less than three cores or more than one voltage source. The system 100 includes other hardware 120 as well. The other hardware may include memory, an interconnection network, a management processor, such as HEWLETT-PACKARD's iLO, etc.

The system 100 may include a virtualized environment. A hypervisor 101 uses the multi-core chip 110 to run multiple VMs 1-s. The hypervisor 101 may run any number of VMs with each VM having any number of virtual CPUs (VC). A virtual CPU may be comprised of the CPU cycles allocated to a VM, which may be from a portion of a core's CPU cycles or cycles from multiple cores. For example, each of the VMs 1-s host an operating system and software applications 106a-s, respectively. The VCs 1-s represent the cores or portions of the cores in the chip 110 assigned to host the VMs. For example, the VMs 1-s utilize the VCs 1-s to run the applications 106a-s. Thus, the VM utilization is the utilization of the VC or VCs hosting the VM or the utilization of the core's CPU cycles assigned to the VC or VM.

The hypervisor 101 also runs a special management VM, shown as MVM. The MVM is a privileged VM that performs power management functions and other management functions. For example, the MVM may include an interface not shown for interfacing with clients and receiving one or more power management policies 104. The power management policies 104 may specify the criteria for making power management decisions. For example, a power management policy may include thresholds for determining when to increase or decrease frequency of a VM. For example, if a VM is at 85% capacity, then the policy may specify to increase frequency. If a VM is at 50% capacity for a predetermined period of time, then the policy may specify to decrease capacity. Other factors may also be considered, such as application performance degradation, overhead for implementing a power management decision, etc. The policies 104 may include other management policies related to the management of VMs.

The MVM includes a management module 105 that monitors the CPU utilization of the VMs 1-s. Based on the utilization and one or more of the power management policies 104, the management module determines the CPU frequency at which the VM's CPU, i.e., the corresponding VC, should run. Also, a management VC, shown as MVC in FIG. 1, represents the virtual CPU for the MVM.

According to an embodiment, the system 100 includes a multi-core power module (MPM) 102 which provides power management mechanisms. For example, the management module 105 requests the MPM 102 to change the frequency of a VC for a VM depending on the VM's CPU utilization and a power management policy. The MPM 102 uses a method 300 described below to provide efficient power management. The MPM 102 may be in the hypervisor 101, so the MPM 102 may communicate with the chip 110 and the MVM.

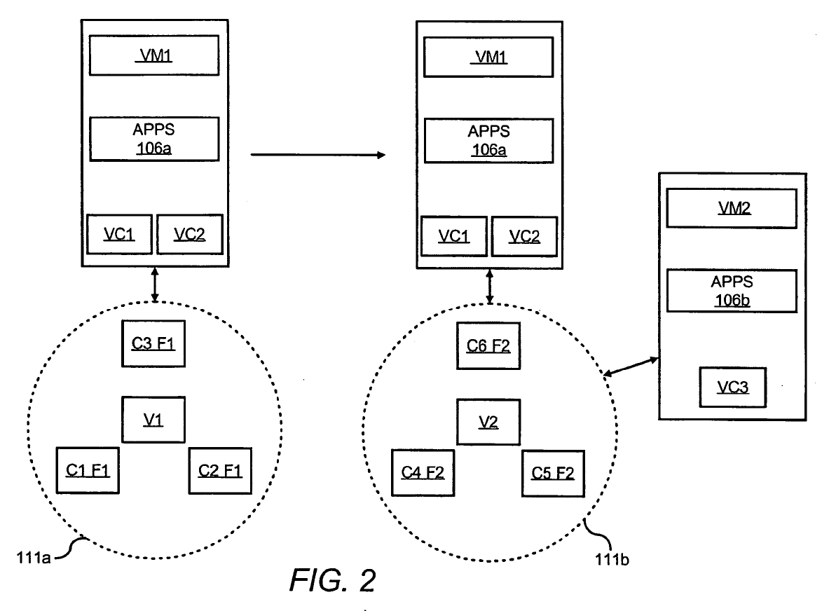

FIG. 2 illustrates an example of power management, according to an embodiment. FIG. 2 shows two clusters 111a and 111b including voltage sources V1 and V2 and cluster frequencies F1 and F2, respectively. The MPM 102 maintains all the cores in a cluster at the same frequency. The cluster frequency is the frequency of the cores in a cluster. Each cluster may have a different cluster frequency. Cluster 111a has a frequency F1 and cluster 111b has a frequency F2. Cluster frequency may be changed by voltage scaling the voltage source.

VM2 is hosted by a core in the cluster 11b. Initially, VM1 is hosted by a core in the cluster 111a. The management module 105, shown in FIG. 1, determines that VM1's CPU frequency is to be changed from F1 to F2, for example, based on a policy and CPU utilization. The management module 105 requests the MPM 102 shown in FIG. 1 to change VM1's CPU frequency from F1 to F2. The MPM 102, instead of changing the frequency of a core in the cluster 111a hosting VM1, migrates VM1 to run on a core belonging to the cluster 111b with the cluster frequency F2. This process is referred to as inter-processor VM migration. Using inter-processor VM migration, the MPM 102 ensures that the request from management module 105 is honored while at the same time providing optimal power saving because of clustering.

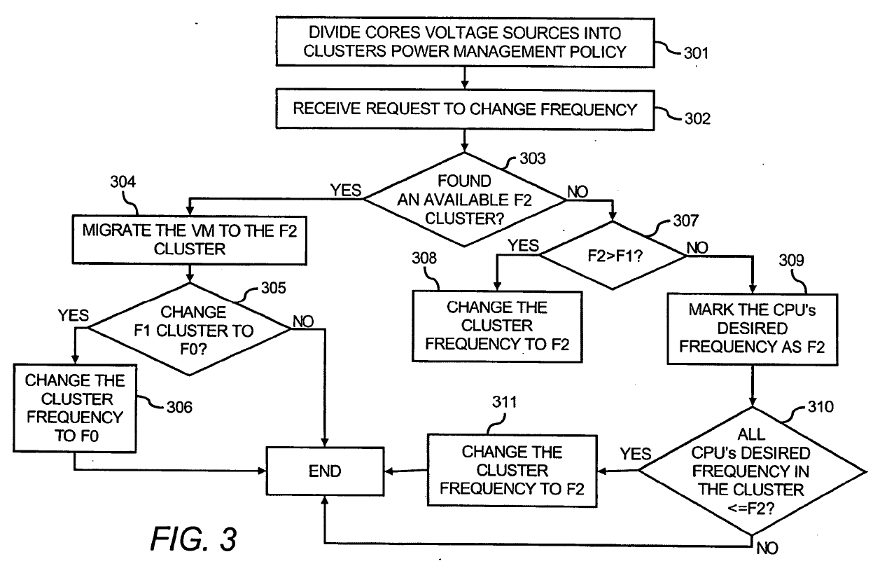

FIG. 3 shows a flow chart of a method 300 for power management, according to an embodiment. The method 300 is described with respect to the system 100 shown in FIG. 1 by way of example and not limitation. The method 300 may be performed in other systems. At step 301, cores and voltages sources on a multi-core chip are divided into clusters. For example, the MPM 102 shown in FIG. 1 scans the multi-core chip 110 to determine the number of cores, number of voltage sources, and the association of cores to voltage sources. This information may be gathered from the cores or a management processor. The MPM 102 builds the volt-cpu-sets (i.e., the clusters) and ensures that all cores in a set run at the same frequency for maximum power savings. Building the volt-cpu-sets, i.e., dividing into clusters, can be based on which voltage source supplies power to which cores.

At step 302, a request is received to change frequency of a VM. For example, the management module 105 determines to change the frequency of a VM from F1 to F2, and sends a request to the MPM 102 to change the VM to F2. The MPM 102 receives the request.

At step 303, a determination is made as to whether a cluster is available with a cluster frequency F2. At step 304, if a cluster is found with F2, the VM is migrated to the new cluster. For example, the MPM 102 searches clusters for a cluster frequency F2. The MPM 102, for example, maintains a table of the clusters and their cluster frequencies. The table may be searched to determine whether a cluster has a frequency of F2. The table may include other information for determining whether sufficient CPU capacity is available in a cluster to handle the load of the VM being migrated. If there are enough CPU cycles available on any of the cores in a cluster with frequency F2, the VM is migrated. If sufficient CPU capacity is not available, the VM may not be migrated or the VM may be migrated to a different cluster with sufficient capacity.

At step 305, after the VM is migrated to the new cluster, a determination is made as to whether the cluster frequency should be changed from F1 to F0. For example, if CPU utilization is low for the entire cluster, which may be due to the migration, the MPM 102 may reduce the cluster frequency to conserve power at step 306 if none of the VMs hosted by the cores in the cluster require F1. All cores in the cluster would be reduced to F0.

At step 303, if an available cluster with a cluster frequency F2 is not found, then the MPM 102 attempts to change the cluster frequency of the current cluster with frequency F1. For example, at step 307, a determination is made as to whether F2 is greater than F1. If F2 is greater than F1, then the cluster frequency is changed to F2 and the VM is not migrated at step 308. If F2 is less than F1, the MPM 102 marks the VM's desired frequency as F2 at step 309 and determines if all the VM's running on all the cores in the cluster have a desired frequency less than or equal to F2 at step 310. If yes, the MPM 102 changes the cluster frequency from F1 to F2 at step 311. The steps of the method 300 may be repeated whenever a request is made to the MPM 102 to change a cluster frequency or whenever a cluster frequency needs to be changed.

The system 100 shown in FIG. 1 illustrates a virtualized environment. The method 300 described above and other steps and functions described herein may be performed in non-virtualized environments. In these cases, the task scheduling can be performed by hardware or software agents aware of the multi-core tradeoffs discussed above.

The embodiments described above generally relate to optimizing the objective function of power savings. Other or additional objective functions may be considered. For example, management policies at the MVM shown in FIG. 1 may include policies for improving performance of applications or maintaining service level objectives for applications. Another broader objective function that addresses power but also considers implications on performance, such as the overhead of clustering and VM migration, the impact of cache sizes, etc., can also be used. This objective function could be particularly relevant in heterogeneous or asymmetric or conjoined multi-core systems.

Also, as described above, power management may include reducing cluster frequencies for power savings. Instead of reducing cluster frequencies, the same concepts may be used to increase cluster frequencies for performance improvements. In this case, a cluster in the multi-core chip would operate in a “performance-boosted” mode with a higher cluster frequency (subject to power delivery and cooling constraints) and higher priority tasks and VMs may be moved to this cluster. For example, a management policy may include running certain VMs at a higher performance. If performance drops, then a request is made to the MPM 102 to move the VM to a higher frequency cluster. If such an available cluster exits, then the VM is migrated to that cluster. Otherwise, the MPM 102 attempts to increase the cluster frequency of the current cluster.

According to another embodiment, power management is performed by identifying power domains in a general power topology. A power domain is, for example, a portion of a total power topology that supplies power to one or more particular components of a system. Also, the power domain or the particular components in the system receiving power in the domain can be controlled independent of other power domains or other components in the system to achieve an objective, such as minimizing power consumption of the particular components of the system. Note that the system described above, for example, includes a computer system or multiple computer systems, and the components may include components of a computer system or entire computer systems, such as individual servers.

The clustering of cores in a multi-core chip based on voltage source supplying power to a cluster is one example of this embodiment. For example, the power topology includes all the voltage sources, and each domain is comprised of one voltage source. The cores in a cluster, which receive power in one power domain, can be independently controlled from other clusters. Other examples, may include clustering other types of components, such as memory. Also, in certain instances, the power supply may be controlled to meet the objective instead of or in addition to controlling the components themselves.

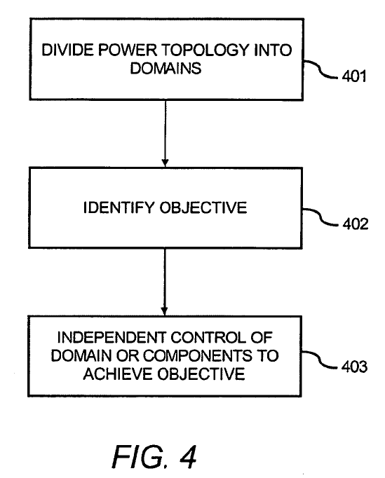

FIG. 4 illustrates a method of power management, according to another embodiment. At step 401, a power topology is divided into domains. This may include identifying different domains in the topology. Each domain is independent of another domain in the power topology, because either components in a system receiving power in a domain can be controlled independent of other components to achieve an objective or because the power supplied in the domain can be controlled independent of other domains. At step 402, the objective associated with power management is identified. The objective may be provided by a system administrator. At step 403, independent control of the domain or components in the domain is performed to achieve the objective. An example of independent control of components includes frequency scaling cores in a cluster. An example of independent control of a domain in a power topology includes reducing the power output in a domain for a computer system or group of computer systems having low utilization and possibly increasing power output for another domain having system components with greater utilization.

One or more of the steps of the methods 300 and 400 other steps described herein may be implemented as software embedded on a computer readable medium, such as the memory and/or data storage, and executed on a computer system, for example, by a processor. Also, the modules described herein may include software. The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

While the embodiments have been described with reference to examples, those skilled in the art will be able to make various modifications to the described embodiments without departing from the scope of the claimed embodiments.

What is claimed is:

1. A method of managing power consumption in a multi-core system including cores and voltage sources supplying power to the cores, the method comprising:
for each core, determining a particular voltage source of the voltage sources supplying power to the core;
dividing the cores in the multi-core system into clusters based on the particular voltage source supplying power to each core; and
managing power consumption of the cores based on utilization of at least one of the cores in the clusters and a management policy.

2. The method of claim 1, wherein managing power consumption comprises:
frequency scaling one or more of the clusters, wherein for each cluster of all the determined clusters, all the cores in the cluster are maintained at a same frequency.

3. The method of claim 1, wherein the multi-core system includes a virtualized environment comprised of a hypervisor and virtual machines hosted by the cores, the method further comprising:
running a multi-core power module inside the hypervisor, wherein the multi-core power module manages the power consumption in accordance with the management policy.

4. The method of claim 3, wherein the multi-core power module comprises a single module loaded inside the hypervisor and manages power consumption for all the cores in the multi-core system.

5. The method of claim 3, further comprising:
communicating decisions based on the management policy from a management virtual machine running in the virtualized environment to the multi-core power module running in the hypervisor.

6. The method of claim 3, further comprising:
the multi-core power module scanning all the cores to identify their voltage sources for creating the clusters.

7. The method of claim 3, wherein performing power management comprises:
receiving an indication that a frequency change from F1 to F2 is needed based on a CPU utilization of a virtual machine hosted by a core in a first cluster of the clusters;
determining whether a second cluster of the clusters has a cluster frequency F2 and is available; and
if the second cluster with cluster frequency F2 exists and is available, migrating the virtual machine to the second cluster.

8. The method of claim 7, further comprising:
after migrating the virtual machine, determining whether all the cores in the second cluster are to be frequency-scaled to reduce power consumption based on CPU utilizations of the cores in the second cluster; and
frequency scaling all the cores in the second cluster to a lower frequency if the determination indicates all the cores are to be frequency-scaled.

9. The method of claim 7, further comprising:
if the second cluster does not exist or is not available, determining whether F2>F1; and
if F2>F1, then changing the frequency of all the cores in the first cluster to F2.

10. The method of claim 9, further comprising:
if F2<F1, then marking a desired frequency for the virtual machine as F2;
determining whether all the cores in the first cluster have a desired frequency less than F2; and
changing the frequency of all the-cores in the first cluster to F2 if all 20 the cores have a desired frequency less than F2.

11. The method of claim 1, wherein the multi-core system contains more cores than voltage sources.

12. The method of claim 1, wherein each cluster contains more cores than voltage sources.

13. The method of claim 1, wherein performing power management comprises:
performing power management based on performance implications of the power management.

14. The method of claim 1, further comprising:
increasing a frequency of all cores in any of the clusters to improve performance of one or more applications hosted by one or more cores in the cluster based on a management policy.

15. A multi-core computer system comprising:
a plurality of cores;
a plurality of voltage sources, wherein the computer system includes more cores than voltage sources;
a multi-core power module dividing the cores in the multi-core system into clusters based on which of the voltage sources supplies power to each core, and, for each cluster, maintaining all the cores in the cluster at a same frequency,
wherein the multi-core power module is operable to perform power management based on a power management policy and CPU utilization of one or more of the cores.

16. The multi-core computer system of claim 15, further comprising:
a hypervisor and virtual machines hosted by the cores in the clusters, and the multi-core power module performs the power management based on CPU utilization of a virtual machine hosted by a core.

17. The multi-core computer system of claim 16, wherein the power management comprises attempting inter-core virtual machine migration and if unsuccessful, attempting frequency scaling of the core running the virtual machine.

18. The multi-core computer system of claim 16, wherein for each cluster, the multi-core power module maintains all the cores in the cluster at a same frequency.

19. A method of power management of a system including one or more computer systems, the method comprising:
divide a power topology into independent domains, wherein power is supplied in each domain to a particular set of cores in a multi-core computer system and the domain is independently controllable, or components of the multi-core computer system in each domain are independently controllable from components in other domains to achieve an objective associated with power management;
identifying the objective associated with power management; and
independently controlling a domain or components of the system in the domain to achieve the objective.

20. The method of claim 19, wherein the objective comprises minimizing power consumption of the system.
